(19) United States
(12) Patent Application Publication
(10) Pub. No.: US 2006/0065352 A1
(43) Pub. Date: Mar. 30, 2006

(54) Stabilized fibrous structures and methods for their production

(76) Inventor: Kenneth Keuchel, Hudson, OH (US)

Correspondence Address: ANDREW F. SAYKO JR, 1014 CROOKED OAKS LANE, SEABROOK ISLAND, SC, 29455-6502, US

(21) Appl. No.: 11/235,809

(22) Filed: Sep. 27, 2005

Related U.S. Application Data
(60) Provisional application No. 60/613,888, filed on Sep. 28, 2004.
(60) Provisional application No. 60/631,104, filed on Nov. 26, 2004.

(51) Int. Cl. B29C 53/82; B29C 65/00

(52) U.S. Cl. 156/155; 156/148; 156/305; 156/322

(57) ABSTRACT

A process is provided for stabilizing a uniaxial fibrous structure comprising: a) positioning a reinforcing fibrous mesh across the uniaxial fibrous structure on the surface of the fibrous structure; b) activating the adhesive of the fibrous mesh from step a); c) and thereby producing a stabilized uniaxial fibrous structure. A process is also provided that comprises producing a composite, multi-layer, high strength laminate from such a stabilized uniaxial fibrous structure or from a fibrous tape.

### CROSS REFERENCE TO RELATED PATENT APPLICATIONS

This patent application claims the benefit of priority of: 1) U.S. Provisional Patent Application Ser. No. 60/613,888 filed on Sep. 28, 2004 and 2) U.S. Provisional Patent Application Ser. No. 60/631,104 filed on Nov. 26, 2004.

### FIELD OF THE INVENTION

The present invention relates to stabilized fibrous structures and methods for making such stabilized fibrous structures. Such stabilized fibrous structures are stabilized to allow them to efficiently and effectively undergo further processing, such as the production of high strength multi-layer laminates, without the need for stitching or weaving to provide additional strength in the cross-machine direction.

### BACKGROUND OF THE INVENTION

Fibrous structures are used in a wide variety of applications, where the engineered qualities of the fibrous structures and the materials from which they are made can be advantageously employed. These types of fibrous structures are integrated into a coherent assembly or structure by a number of methods well known in the prior art.

These fibrous structures may be formed from high tensile strength materials such as carbon, graphite, Kevlar® poly-paraphenylene terephthalamide, high molecular high density weight polyolefins, highly oriented polyolefins, fiber glass, etc., to manufacture high strength fabrics, such as multi-layer preforms or prepregs. Such high strength fabrics may then be subjected to resin infusion whereby a high strength adhesive material, such as for example, an epoxide or a polystyrene is infused into the fabric structure to thereby form a high strength composite laminate. Such infusion processes for distributing the high strength adhesive throughout the fabric structure include, for example, resin transfer molding, vacuum assisted infusion and resin film infusion.

Fibrous structures, such as yarns and fibrous tapes (tapes produced from fiber-forming materials) are normally produced by a process whereby the resulting fibrous structure exhibits very good strength in the machine direction, but has very little integrity or strength in the cross-machine direction. As a result, such fibrous structures may be layered at about a 90 degree angle to provide a structure that exhibits strength and integrity in both the machine and cross-machine direction.

When such fibrous structures, which are uniaxial in strength and stability, are used in a process to form a fabrics by the parallel positioning of a multiplicity of such uniaxial fibrous structures, the resulting fabric is also uniaxial. Although this is a simple and cost efficient method for producing fabrics, such fabrics have very little strength or stability in the cross-machine direction and are not readily handled during subsequent processing.

In the past, uniaxial fabrics have been stabilized by a number of methods that provide increased strength and stability in the cross-machine direction. Durable nonwoven fibrous structures have often relied upon relatively high levels of thermal bonding, surface treatments with an adhesive to bond the surface of the fabrics, or stitch bonding techniques to provide a stabilized fibrous network. U.S. Pat. No. 5,192,600 and U.S. Pat. No. 5,623,888 disclose stitch bonding technology for the production of stabilized nonwoven fibrous structures, with the bulky fabrics described therein stated as being useful in a variety of apparel and industrial end uses. U.S. Pat. No. 5,288,348 and U.S. Pat. No. 5,470,640 disclose high loft, durable nonwoven fibrous structures that fibrous structures are produced by serial bonding of layers, followed by an all-over surface bonding with a greater bond area than any of the intermittent bonding steps.

In stitch bonding, a cross woven filament or thread is provided at intervals of about one inch along the length of the uniaxial fabric. If a meltable filament or thread is used, it does not have to be stitched into the fibrous structure of the fabric, but is usually melted across the width of the uniaxial fabric. In these prior art methods, the speed and efficiency of the stabilization process is usually limited by the speed and efficiency of the mechanism utilized to position the filament or thread across the width of the uniaxial fibrous structure being stabilized.

### SUMMARY OF THE INVENTION

Both the machine direction and the cross-machine direction of a uniaxial fibrous structure or a fibrous assembly require stability to enable efficient handling and subsequent processing of the structure without at least partially destroying the parallel fiber assembly pattern of such a fibrous structure. In the process of the present invention, such fibrous structures include yarns and fibrous tapes. A multiplicity of such fibrous structures may be positioned parallel to one another to provide a fibrous assembly.

In the present invention, to stabilize such uniaxial fibrous structures, one utilizes a fibrous mesh, which is a reinforcing random or regular fibrous mesh. Such a fibrous mesh may be a loosely woven mesh, or a regular or random nonwoven web. The fibrous mesh may be produced from a polymer and/or polymer blend having adhesive properties when the surface of the structure is softened or melted. The fibrous mesh may also be formed from bicomponent (sheath/core or side-by-side) fibers or filaments, wherein the lower melting point component is softened or melted during the initial stabilization process, upon the application of the appropriate degree of heat. A fibrous mesh may also be produced that contains an adhesive on its surface. Such an adhesive may be, for example, in the form of a meltable powder binder resin, a paste binder, or a meltable adhesive web or film that adheres to both the fibrous mesh and the fibrous structure being stabilized.

The adhesive fibrous mesh is positioned across the uniaxial fibrous structure and, where necessary, heated to a temperature high enough to soften the surface of the adhesive fibrous mesh or the adhesive on the surface of the fibrous mesh. Such a process provides good adhesion, without weakening the cohesion of the fibrous structure to be bonded. The present stabilization process substantially eliminates splitting of the edges of the structure, thereby reducing waste, improving productivity and providing a higher quality product.

Unlike thread-stabilization by incorporating filaments within the fiber bundles, a layer of an adhesive fibrous mesh or the adhesive from the surface of the fibrous mesh is fused to the fibrous assembly without traversing its fibrous structure. This bonding system produces minimal changes in the fiber density of the fibrous structure being bonded because fiber penetration and bunching is minimized or substantially eliminated. More than a minimal change in fiber density could cause stress concentrations in the final laminated composite structure, which often results in weak spots.

Initially, uniaxial fibrous structures may comprise a loose assembly of multifilament reinforcing yarns arranged in parallel, in the machine direction. Alternatively, such a fibrous structure may comprise a fibrous tape, which can be a fibrous tape, a compression molded tape, a drawn compression molded tape, or a fiber reinforced tape. These uniaxial fibrous assemblies have virtually no integrity or strength in the cross-machine direction, and cannot be easily moved or handled in subsequent operations without at least partially destroying their parallel yarn arrangement.

In order to reinforce such a fibrous structure, in the cross-machine direction, the present invention uses one of the following methods to stabilize the initially unstable fibrous assembly, particularly in the cross-machine direction.

1) A reinforcing fibrous mesh comprising a polymer that is an adhesive when the surface thereof is softened or melted, or comprising at least a layer of such an adhesive polymer, that is adhered to one or both sides of the uniaxial fibrous structure.

2) A reinforcing fibrous mesh is coated with a liquid or paste adhesive and adhered to one or both sides of the uniaxial fibrous structure.

3) A fibrous mesh comprising monofilament binder fibers that function as an adhesive when the surface thereof is softened or melted, such as sheath/core or side-by-side multi-component binder filaments or fibers, or adhesive-coated filaments or fibers, are bonded across the width of the uniaxial fibrous structure, and adhered to the surface of the fibrous structure. Based on a Hook Pull Test study, cross-fabric integrity increases with melt temperature and melt penetration of the adhesive into the fibrous structure.

The above-described methods will stabilize the lay-up matrix of the reinforcing fibers of the uniaxial fibrous structure and facilitate handling as a stable fibrous structure in subsequent operations, such as plying, either as a unidirectional fabric or a multi-axial fabric. Depending on which reinforcing fibers or filaments are used, an improvement in tensile strength, elongation, elasticity and/or anti-ballistic properties of the resulting multi-layer composite fabric can be obtained.

When manufacturing a hard or soft armor or anti-ballistic composite system, it is well known that the performance of such a composite system is vastly improved if the layers of such performance composites are layered at a significant angle to one another. Cutting the uniaxial fibrous structure from which the composite is manufactured often causes the edges of the fibrous structure to fray or the fibrous structure to split at the ends. This detrimentally affects the performance of the composite if such a damaged fibrous structure is utilized as a layer of such a composite. The bonding of the reinforcing fibrous mesh significantly reduces and often substantially eliminates the tendency of a uniaxial fibrous structure to fray or split at the ends, if it is cut and handled. Such bonding also results in less scrap, higher quality products, and allows less adhesive or binder resin to be used to produce a stabilized fibrous structure with more fiber mobility and flexibility.

In the present invention, the unidirectional (uniaxial) fibers of the fibrous structure to be stabilized may be yarns, filaments or fibers. The reinforcing fibrous mesh may be a woven or nonwoven netting product, a woven scrim, a mesh comprising either positioned monofilaments that are thermally-fused in position or multi component fibers or filaments (e.g. sheath/core or side-by-side). The reinforcing fibrous mesh may already be coated with a thermally meltable material, or can have a “wet” or dry glue component or a PSA (pressure sensitive adhesive) coating on its surface. In subsequent processing to form a multi-layer composite laminate, this type of system will normally preclude the need for an additional binder material, which is usually required in the form of a web, powder or spray.

The present invention provides multi-layer fibrous composite laminate structures wherein a fibrous mesh of reinforcing filaments, which may be in the form of a web, tape or netting, is “locked in-place” to stabilize the multi-layer fibrous structure. Of special importance in providing high strength laminates are multi-layer fibrous structures having good tensile strength, such as fibers, filaments or structures in the form of extruded netting, or elastomeric filaments that easily recover from deformation.

Multi-directional, high strength composites may comprise stabilized uniaxial fibrous structures containing parallel fibers, filaments, tapes and/or yarn assemblies of uniaxial and/or cross-machine directional oriented layers. Stabilized uniaxial fibrous structures can be used to produce both types of oriented fibrous layers. To produce a high strength multi-layer fibrous composite having cross-machine directional layers, multiple uniaxial stabilized fibrous structures (e.g. yarn bundles or assemblies, or tapes) are pre-positioned in a desired configuration for subsequent handling and processing. Such a process for producing a composite, multi-layer, high strength laminate from such stabilized uniaxial fibrous structures comprises one of the following steps 1), or 2):
1) Cross-lapping and folding over a unidirectional (uniaxial) fibrous structure at a bias angle of from about +/−10 to 80 degrees, preferably +/−20 to 60 degrees, more preferably from about +/−30 to 50 degrees and most preferably about +/−45 degrees (with regard to the machine direction); or
2) Passing a uniaxial fibrous structure, at a bias angle of from about +/−10 to 80 degrees, preferably from about +/−30 to 60 degrees, more preferably from about +/−40 to 50 degrees and most preferably about +/−45 degrees (with regard to the machine direction), over a rotating frame or roll in a manner such that the bias angle is maintained and the uniaxial fibrous structure cross-laps and folds over at such bias angle;
3) Then super-imposing the desired configurations of the stabilized uniaxial fibrous structure product of step 1) or 2) in a desired sequence of layers to produce the lay-up pattern (preform) used for producing the final composite multi-layer fibrous laminate structure;
4) Then, applying an adhesive or binder resin and, optionally, infusing said adhesive or binder resin into the fibrous structure of the preform product of step 3); 5) Then processing the preform product of step 4) and thereby activating the adhesive and thereby provide a composite, multi-layer, high strength fibrous laminate structure.

After producing the stabilized fibrous structure or using a sufficiently stable uniaxial fibrous tape, such a fibrous structure can be cross lapped at an angle of +/−10 to 80 degrees, most preferably about +/−45 degrees, with regard to the preceding layer, utilizing the method of the present invention. Thus, with a uniaxial fibrous tape, the tape is not cut or handled in a manner that causes the tape to have edge fraying or splitting of the ends.

If the initial uniaxial fibrous structure is sufficiently stable, infusion of an adhesive or binder resin may not be necessary, in forming the final composite. In fact, the infusion of the adhesive or binder resin may provide a product that is stiffer and less flexible than desired for the intended end-use, e.g. in anti-ballistic applications.

### DESCRIPTION OF THE DRAWINGS

FIG. 1 illustrates the stabilization of one of the layers (uniaxial lay-up) of a fibrous structure. From a yarn beam 1; a uniaxial fibrous structure 2 is passed between two rolls 3 and 4; each containing a nonwoven web 5 and 6; to provide a fibrous assembly 7; which is pulled along conveyer belt 7; driven by bottom rolls 8, 9, 10, 11 and top rolls 12, 13, 14, 15; passed over a heating plate 16; conveyed between heating plates 17 and 18 and then heating plates 19 and 20; passed between pressure nip rolls 21 and 22; conveyed between cooling plates 23 and 23; to provide a stabilized uniaxial fibrous structure 24.

FIG. 2 illustrates a multi-axial plying operation (multi-axial lay-up) for producing a folded cross-oriented composite fibrous assembly. A stabilized uniaxial fibrous structure 33 is supplied from a roll 31 positioned at a 45 degree bias angle with regard to conveyor belt 32 (the machine direction); driven by bottom rolls 35, 36, 37, 38; the fibrous structure 33 is conveyed to top conveyor belt 34 driven by top rolls 39, 40, 41, 42; passed over a heating plate 43; conveyed between heating plates 44 and 45 and then heating plates 46 and 47; passed between pressure nip rolls 48 and 49; conveyed between cooling plates 50 and 51; to provide a composite prepreg (preform) 52.

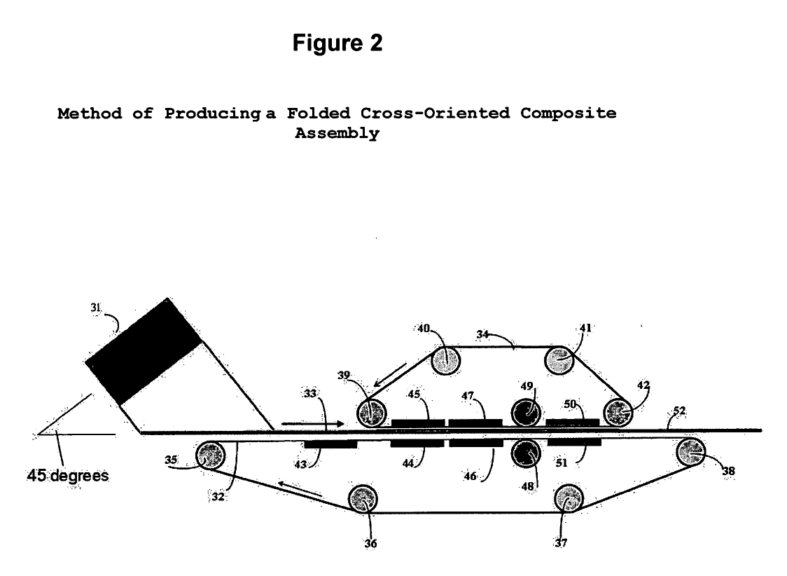

FIG. 3 illustrates the folding pattern of the stabilized uniaxial fibrous structure 33 of FIG. 2 on the roll 31 of FIG. 2. The roll 61 has rolled up thereon a folded uniaxial fibrous structure 62 having a +/−45 degree bias angle on roll 61.

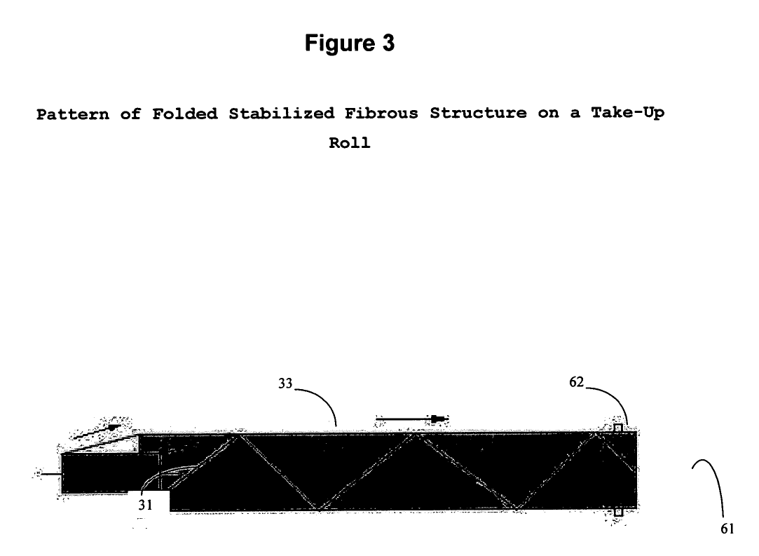

### DESCRIPTION OF THE PREFERRED EMBODIMENTS

A process is provided for stabilizing a uniaxial fibrous structure comprising:

a) positioning a reinforcing fibrous mesh positioned across the uniaxial fibrous structure on the surface of the fibrous structure, wherein the fibrous mesh either:

1) comprises a polymer and/or polymer blend capable of functioning as an adhesive when the surface of the structure is softened or melted; or

2) comprises bicomponent (sheath/core or side-by-side) fibers or filaments, wherein the lower melting point component is capable of being softened and acting as an adhesive upon the application of heat; or

3) contains an adhesive on or binder resin on its surface; and

b) activating the adhesive of the fibrous mesh from step a);

c) and thereby producing a stabilized uniaxial fibrous structure.

The uniaxial fibrous structure to be stabilized preferably comprises a loose assembly of multifilament reinforcing yarns arranged in parallel in the machine direction, or a fibrous tape. Such fibrous structures may be formed from high tensile strength materials such as carbon, graphite, Kevlar® poly-paraphenylene terephthalamide, a high density high molecular weight polyolefin, a highly oriented polyolefin or fiber glass.

A process is also provided for producing a composite, multi-layer, high strength laminate from the above-described stabilized uniaxial fibrous structure, the process comprising:
1) one of steps a), b) or c):
   a) cross-lapping and folding over a unidirectional (uniaxial) fibrous structure to provide a multi-layer fibrous structure, at a bias angle of from about +/−10 to 80 degrees, preferably +/−30 to 60 degrees, more preferably from about +/−40 to 50 degrees and most preferably about +/−45 degrees (with regard to the machine direction); or
   b) passing a uniaxial fibrous structure over a rotating frame or roll, at a bias angle of from about +/−10 to 80 degrees, preferably +/−30 to 60 degrees, more preferably from about +/−40 to 50 degrees and most preferably about +/−45 degrees (with regard to the machine direction) over a rotating frame or roll in a manner such that the bias angle is maintained and the uniaxial fibrous structure cross-laps and folds over at such bias angle;
2) super-imposing the desired configurations of the stabilized uniaxial fibrous structure from step a) or b) in a desired sequence of layers to produce a lay-up pattern preform useful for producing a composite multi-layer fibrous laminate structure; and
3) applying an adhesive or binder resin to the preform of step 2) in an amount sufficient to provide structural integrity to said preform and, optionally, infusing said adhesive or binder resin into the fibrous structure of the preform of step 2); and
4) activating the adhesive of the preform of step 3); and
5) thereby providing a composite, multi-layer, high strength fibrous laminate structure.

A process is also provided for producing a composite, multi-layer, high strength laminate, the process comprising:

a) positioning a reinforcing fibrous mesh across the uniaxial fibrous structure on the surface of said fibrous structure, wherein said mesh either:

1) comprises a polymer and/or polymer blend capable of functioning as an adhesive when the surface of the structure is softened or melted;
2) comprises bicomponent fibers or filaments, wherein the lower melting point component is capable of being softened and acting as an adhesive upon the application of heat; or
3) contains an adhesive on its surface; and
   b) activating the adhesive of said fibrous mesh from step a); and
   c) thereby producing a stabilized uniaxial fibrous structure; and
   d) subjecting said stabilized u8niaxial fibrous structure to one of steps I) or II):

I) cross-lapping and folding over said uniaxial fibrous structure at a bias angle of from about +/−10 to 80 degrees, preferably +/−30 to 60 degrees, more preferably from about +/−40 to 50 degrees and most preferably about +/−45 degrees (with regard to the machine direction); or
II) passing said uniaxial fibrous structure, at a bias angle of from about +/−10 to 80 degrees, preferably +/−30 to 60 degrees, more preferably from about +/−40 to 50 degrees and most preferably about +/−45 degrees (with regard to the machine direction) over a rotating frame or roll in a manner such that the bias angle is maintained and the uniaxial fibrous structure cross-laps and folds over at such bias angle; and
   e) super-imposing the desired configurations of the stabilized uniaxial fibrous structure from step I) or II) in a desired sequence of layers to produce a lay-up pattern preform useful for producing a composite multi-layer fibrous laminate structure; and
   f) applying an adhesive or binder to the preform of step e) in an amount sufficient to provide structural integrity to said preform and, optionally, infusing said adhesive or binder resin into the fibrous structure of the preform of step e); and
   g) activating the adhesive of the preform of step f); and
   h) thereby providing a composite, multi-layer, high strength fibrous laminate structure.

A process is also provided for producing a composite, multi-layer, high strength fibrous laminate structure, the process comprising:
1) one of steps a), b) or c):
   a) cross-lapping and folding over a unidirectional (uniaxial) fibrous tape at a bias angle of from about +/−10 to 80 degrees, preferably +/−30 to 60 degrees, more preferably from about +/−40 to 50 degrees and most preferably about +/−45 degrees (with regard to the machine direction); or
   b) passing a uniaxial fibrous tape, at a bias angle of from about +/−10 to 80 degrees, preferably +/−30 to 60 degrees, more preferably from about +/−40 to 50 degrees and most preferably about +/−45 degrees (with regard to the machine direction) over a rotating frame or roll in a manner such that the bias angle is maintained and the uniaxial fibrous structure cross-laps and folds over at such bias angle; and
2) super-imposing the desired configurations of the stabilized uniaxial fibrous tape from step a) or b) in a desired sequence of layers to produce a lay-up pattern useful for producing a composite multi-layer fibrous laminate structure; and
3) applying an adhesive or binder resin to the surface of said fibrous of step 2) in an amount sufficient to provide structural integrity to said preform and, optionally, infusing said adhesive or binder resin into the fibrous structure of the preform of step 2); and
4) activating the adhesive of the preform of step 3); and
5) thereby providing a composite, multi-layer, high strength fibrous laminate structure.

The reinforcing fibrous mesh of the present invention can be fabricated from a two-component fiber system. The first component melts at a lower temperature and initially bonds the reinforcing fibrous mesh to the surface of the uniaxial fibrous structure, and the second component melts at a higher temperature. The initial bonding of the fibrous mesh to the surface of the uniaxial fibrous structure is accomplished to allow mobility of the inner filaments when pre-forming the structure around a complex surface. Such a reinforcing fibrous mesh may be fabricated from a second component that has a higher melting point, compatible material that is melted after forming the shape of the final composite around a complex surface. If there is sufficient mass of such a reinforcing fibrous mesh, the reinforcing fibrous mesh can provide the resin matrix needed to solidify the multi-layer composite fibrous structure that may be formed from a fibrous structure stabilized using such a reinforcing fibrous mesh.

### EXAMPLE 1

### Stabilization of a Multitude of a Parallel Laid Fibrous Assembly

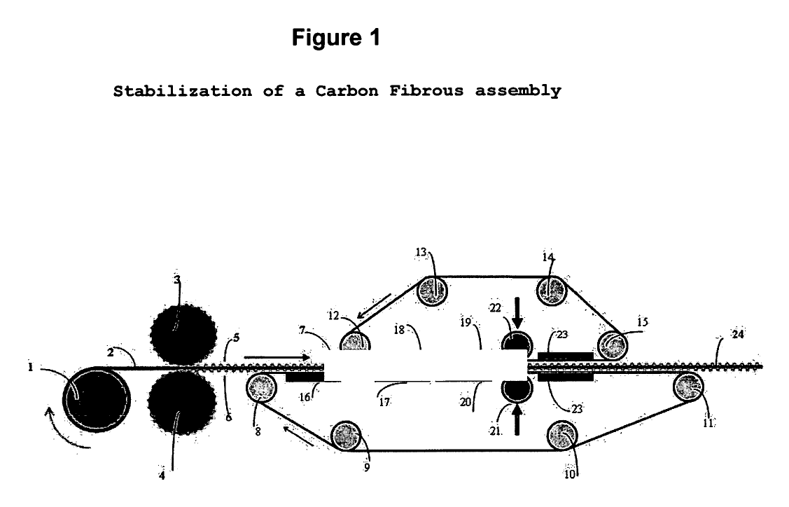

The method of Example 1 stabilized a loosely laid, parallel (uniaxial) aramide fibrous assembly (Twaron® aramide available from Teijin Twaron of Taiwan) in an amount sufficient to provide structural integrity to said fibrous assembly using a nonwoven fibrous mesh made of a polymer having adhesive properties. FIG. 1 illustrates a procedure for stabilizing such a fibrous assembly of parallel yarns. The aramide fibrous assembly was supplied from a beam. Each yarn bundle was separated by a guide system to distribute the filaments evenly, as one layer, across the width of 16 inches into a uniaxial fibrous assembly of loose fibers. The yarn contained 12 strands of 1000 denier per filament. The fibrous assembly was pulled, at a line speed of about 20 feet per minute, by the conveyor belt of the bonder and onto a winder. Prior to entering the bonder, which was maintained at a temperature of 310° F., the aramide fibrous assembly was contacted with a nonwoven adhesive fibrous mesh, as shown in FIG. 1. The adhesive mesh was a self-bonded nonwoven POX 80519 polyolefin web, available from Spunfab Ltd. The nonwoven web was laid onto the surface of the aramide fibrous assembly, passed as a composite structure through the bonder, under controlled temperature and pressure to just soften, but not melt, the surface of the adhesive non-woven web. After leaving the bonder and subsequent cooling of the structure, the final pre-laminate composite was rolled up on a winder. The loose aramide fibers were bonded and fixed-in place by the softened polymeric adhesive nonwoven web in a stabilized fibrous structure. The resulting fibrous structure had sufficient strength to withstand the subsequent processing used to convert it into the final composite laminate structure.

### EXAMPLE 2

### Lamination of the Stabilized Uniaxial Multi-Layered Yarn Assembly Produced in Example-1

In a second operation the uniaxially arranged cross-stabilized fibrous structure of Example 1 is cut on a +/−45 degree bias to the machine direction assembly and positioned precisely over one continuous assembly of uniaxially arranged aramide fiber yarns. These layers are multi-plied as desired (here 4 layers) to form a lay-up and are put into a molding envelope having a contoured surface and a flexible membrane encasing the 4-layer lay-up. Fittings are provided to pull a vacuum through the cross section of the layers comprising the lay-up, thereby causing a liquid binder resin to penetrate the fibrous structure of the reinforcing carbon fibers. Heat is optionally applied to reduce binder resin viscosity, facilitate penetration of the reinforcing fibers lay-up, remove entrapped air and facilitate binder resin curing. The resulting product is a 4-layer aramide fiber composite laminate that may be used to form any of a number of high strength shaped articles.

### EXAMPLE 3

Six strands of a three-inch wide tape of Tensylon® high molecular weight, high density polyethylene (available from Integrated Textile Systems), having an average thickness of 0.0070 inch are fed from a creel through a guide system to thereby form a tightly spaced assembly of side-by-side tapes. The resulting fibrous tape assembly is covered on both the top and bottom with a light nonwoven web of Spunfab POX 80519 co-polyamide adhesive having a weight of 13 grams per square meter. The fibrous tape assembly is then fed between a pair of conveyer belts through a continuous flat bed laminator maintained at a temperature of 220° F., using a nip pressure within the laminator of 40 pounds per square inch (psi). The laminated stabilized fibrous structure then exits the laminator and is wound onto a cooling roll and then stored for subsequent processing.

### EXAMPLE 4

The stable uniaxial fibrous structure of Example 3 was then positioned at a 45 degree angle to the vertical (machine direction) of the input side of a flat bed laminator. Guide rails were placed on the in-feed conveyor belt prior to the input side of the laminator to facilitate fan-like folding over of the fibrous structure prior to entering the laminator. Each fold layer was successively positioned at an angle of +45 degrees and then −45 degrees, relative to the machine direction. Prior to entering the laminator, the edges of the folded over laminate were hand smoothed to crease the fold over. The laminate was then passed through the laminator, which was maintained at a temperature of 220° F., using a nip pressure within the laminator of 40 psi. A winder was positioned at the output end of the laminator to thereby take up the multi-layer laminate. This yielded about 50% of the original feed width of the multi-layer laminate of Example 3.

### EXAMPLE 5

The procedure of Example 3 was repeated using Kevlar® poly-paraphenylene terephthalamide (available from DuPont).

### EXAMPLE 6

The stabilized uniaxial multi-layer Kevlar® poly-paraphenylene terephthalamide laminate of Example 5 was then subjected to a Hook Pull Test (described below) to test its stability (Hook Strength) versus an identical unstabilized fibrous structure. The stabilized laminate showed little deformation the cross-machine direction at a load of 38.18 grams in. The identical unstabilized fibrous structure showed deformation in the cross-machine direction starting at a load of 1.909 grams in the cross-machine direction and at a load of 7.636 grams showed substantial deformation.

### Test Method

### Relative Hook-Strength of Fiber Assemblies

Materials used:

a. Uniaxial fibrous assemblies with cross-directional (90°) fibers;
b. An adhesive fibrous mesh;
c. Fibrous assembly is surface bonded with the adhesive mesh to stabilize the initial fibrous assembly.
   Purpose of the tests:
a. To determine the optimal bonding temperature between materials; and/or
b. To determine the maximum cross-directional load the composite can support.
   Procedure:
1. The surface-bonded sample of fibrous assembly with filaments aligned horizontally is held by a pair of jaws or clamps.
2. A thin hook is inserted between yarn-filaments in the cross-machine direction.
3. Weights are added to the hook to progressively increase the cross-directional load on the fibrous assembly.
4. Changes in separation, if any, from the point of hook insertion are noted.
5. The load producing a yarn separation in excess of 2.00 mm is considered the relative Hook-strength.

### EXAMPLE 7

One strand of an 18-inch wide tape of Tensylon® high molecular weight, high density polyethylene (available from Integrated Textile Systems), having an average thickness of 0.0070 inch is fed from a roll and was then positioned at a 45 degree angle to the vertical of the input side of a flat bed laminator. Guide rails were placed on the in-feed conveyor belt prior to the input side of the laminator to facilitate fan-like folding over of the laminate prior to entering the laminator. Each fold layer was successively positioned at an angle of +45 degrees and then −45 degrees, relative to the machine direction. Prior to entering the laminator, the edges of the folded over laminate were hand smoothed to crease the fold over. The laminate was then passed through the laminator, which was maintained at a temperature of 220° F., using a nip pressure within the laminator of 40 psi. A winder was positioned at the output end of the laminator to thereby take up the multi-layer laminate. This yielded about 50% of the original feed width of the original multi-layer laminate.

Having described the invention what I desire to claim is:

1. A process for stabilizing a uniaxial fibrous structure, the process comprising:
a) positioning a reinforcing fibrous mesh across said uniaxial fibrous structure on the surface of said fibrous structure, wherein said fibrous mesh either:
1) comprises a polymer and/or polymer blend capable of functioning as an adhesive when the surface of the structure is softened or melted;
2) comprises bicomponent fibers or filaments, wherein the lower melting point component is capable of being softened and acting as an adhesive upon the application of heat; or
3) contains an adhesive on its surface; and
b) activating the adhesive of said fibrous mesh from step a);
c) and thereby producing a stabilized uniaxial fibrous structure.

2. The process of claim 1, wherein said uniaxial fibrous structure consists essentially of a loose assembly of multifilament reinforcing yarns arranged in parallel, in the machine direction.

3. The process of claim 1, wherein said uniaxial fibrous structure consists essentially of one or more fibrous tapes.

4. The process of claim 1, wherein said uniaxial fibrous structure comprises a high tensile strength material selected from carbon, graphite, poly-paraphenylene terephthalamide, a high molecular weight high density polyolefin, a highly oriented polyolefin or fiber glass.

5. The process of claim 1, further comprising producing a composite, multi-layer, high strength laminate from said stabilized uniaxial fibrous structure of claim 1 wherein said process consists essentially of:
1) one of steps a) or b):
a) cross-lapping and folding over said stabilized uniaxial fibrous structure at a bias angle of from about +/−10 to 80 degrees (with regard to the machine direction); or
b) passing said stabilized uniaxial fibrous structure, on a bias angle of from about +/−10 to 80 degrees (with regard to the machine direction) over a rotating frame or roll in a manner such that the bias angle is maintained and the uniaxial fibrous structure cross-laps and folds over at such bias angle;
2) super-imposing the desired configurations of the stabilized uniaxial fibrous structure from step a), or b) in a desired sequence of layers to produce a lay-up pattern preform useful for producing a composite multi-layer fibrous laminate structure; and
3) applying an adhesive or binder resin to the surface of the preform of step 2) in an amount sufficient to provide structural integrity to said preform and, optionally, infusing said adhesive or binder resin into the fibrous structure of the preform of step 2); and
4) activating the adhesive of the preform of step 3); and
5) thereby providing a composite, multi-layer, high strength fibrous laminate structure.

6. The process of claim 5, wherein the uniaxial fibrous structure comprises a high tensile strength material selected from carbon, graphite, poly-paraphenylene terephthalamide, a high molecular weight high density polyolefin, a highly oriented polyolefin or fiber glass.

7. The process of claim 5, wherein the bias angle of step 1) is from about +/−30 to 60 degrees.

8. The process of claim 5, wherein the bias angle of step 1) is from about +/−40 to 50 degrees.

9. A process for producing a composite, multi-layer, high strength laminate comprising:
a) positioning a reinforcing fibrous mesh across a uniaxial fibrous structure on the surface of said uniaxial fibrous structure, wherein said fibrous mesh either:
1) comprises a polymer and/or polymer blend capable of functioning as an adhesive when the surface of the structure is softened or melted;
2) comprises bicomponent fibers or filaments, wherein the lower melting point component is capable of being softened and acting as an adhesive upon the application of heat; or
3) contains an adhesive on its surface; and
b) activating the adhesive on said fibrous mesh from step a); and
c) thereby producing a stabilized uniaxial fibrous structure; and
d) subjecting said stabilized uniaxial fibrous structure to one of steps I) or II):
I) cross-lapping and folding over said stabilized uniaxial fibrous structure at a bias angle of from about +/−10 to 80 degrees (with regard to the machine direction); or
II) passing said stabilized uniaxial fibrous structure, on a bias angle of from about +/−10 to 80 degrees (with regard to the machine direction) over a rotating frame or roll in a manner such that the bias angle is maintained and the stabilized uniaxial fibrous structure cross-laps and folds over at such bias angle;
e) super-imposing the desired configurations of the stabilized uniaxial fibrous structure from step I) or II) in a desired sequence of layers to produce a lay-up pattern preform useful for producing a composite multi-layer fibrous laminate structure; and
f) applying an adhesive or binder resin on the surface of the preform of step e) in an amount sufficient to provide structural integrity to said preform and, optionally, infusing said adhesive or binder resin into the fibrous structure of the preform of step e); and
g) activating the adhesive of the preform of step f); and
h) thereby providing a composite, multi-layer, high strength fibrous laminate structure.

10. The process of claim 9, wherein said uniaxial fibrous structure consists essentially of a loose assembly of multifilament reinforcing yarns arranged in parallel, in the machine direction.

11. The process of claim 9, wherein said uniaxial fibrous structure consists essentially of a fibrous tape.

12. The process of claim 9, wherein said uniaxial fibrous structure comprises a high tensile strength material selected from carbon, graphite, poly-paraphenylene terephthalamide, a high molecular weight high density polyolefin, a highly oriented polyolefin or fiber glass.

13. The process of claim 9, wherein said bias angle of step I) or II) is from about +/−30 to 60 degrees.

14. The process of claim 9, wherein said bias angle of step I) or II) is from about +/−40 to 50 degrees.

15. A process for producing a composite, multi-layer, high strength fibrous laminate structure, the process comprising:
1) one of steps a), b) or c):
a) cross-lapping and folding over a uniaxial fibrous tape at a bias angle of from about +/−10 to 80 degrees (with regard to the machine direction); or
b) passing a uniaxial fibrous tape, at a bias angle of from about +/−10 to 80 degrees (with regard to the machine direction) over a rotating frame or roll in a manner such that the bias angle is maintained and the uniaxial fibrous structure cross-laps and folds over at such bias angle;
2) super-imposing the desired configurations of the stabilized uniaxial fibrous tape from step a) or b) in a desired sequence of layers to produce a lay-up pattern preform useful for producing a composite multi-layer fibrous laminate structure; and
3) providing an adhesive or binder resin on the surface of said preform of step 2) in an amount sufficient to provide structural integrity to said preform; and
4) activating the adhesive or binder resin on the preform of step 3); and
5) thereby providing a composite, multi-layer, high strength fibrous laminate structure.

16. The process of claim 15, wherein said uniaxial fibrous tape comprises a high tensile strength material selected from carbon, graphite, poly-paraphenylene terephthalamide, a high molecular weight high density polyolefin, a highly oriented polyolefin or fiber glass.

17. The process of claim 15, wherein said bias angle of step a) or b) is from about +/−30 to 60 degrees.

18. The process of claim 15, wherein said bias angle of step a) or b) is from about +/−40 to 50 degrees.
